(19) United States
(12) Patent Application Publication
(10) Pub. No.: US 2017/0043607 A1
(43) Pub. Date: Feb. 16, 2017

(54) Christmas Tree Greeting Card

(71) Applicant: American Greetings Corporation, Cleveland, OH (US)

(72) Inventor: Toby Seadler, Paradise Valley, AZ (US)

(21) Appl. No.: 15/231,833

(22) Filed: Aug. 9, 2016

Related U.S. Application Data
(60) Provisional application No. 62/203,500, filed on Aug. 11, 2015.

(51) Int. Cl. B42D 15/02; B42D 15/04

(52) U.S. Cl. CPC B42D 15/022; B42D 15/04

(57) ABSTRACT

The greeting card of the present disclosure and related inventions combines a traditional greeting card with a three-dimensional object, such as a faux Christmas tree, which is capable of movement and audio playback.

### RELATED APPLICATIONS

This application is a non-provisional of and claims priority to U.S. Provisional Patent Application No. 62/203,500, filed on Aug. 11, 2015, a copy of which is incorporated herein by reference in its entirety.

### FIELD OF THE INVENTION

The present invention is in the field of social expression products, and more specifically is directed to interactive greeting cards having motion and audio capabilities.

### SUMMARY OF THE INVENTION

The present invention includes a greeting card having a three-dimensional Christmas tree attached thereto. The Christmas tree, upon interaction with a user, is capable of movement via a motor module and audio replay via a sound module.

### DESCRIPTION OF THE DRAWINGS

FIG. 1 is a perspective view of the greeting card of the present invention.

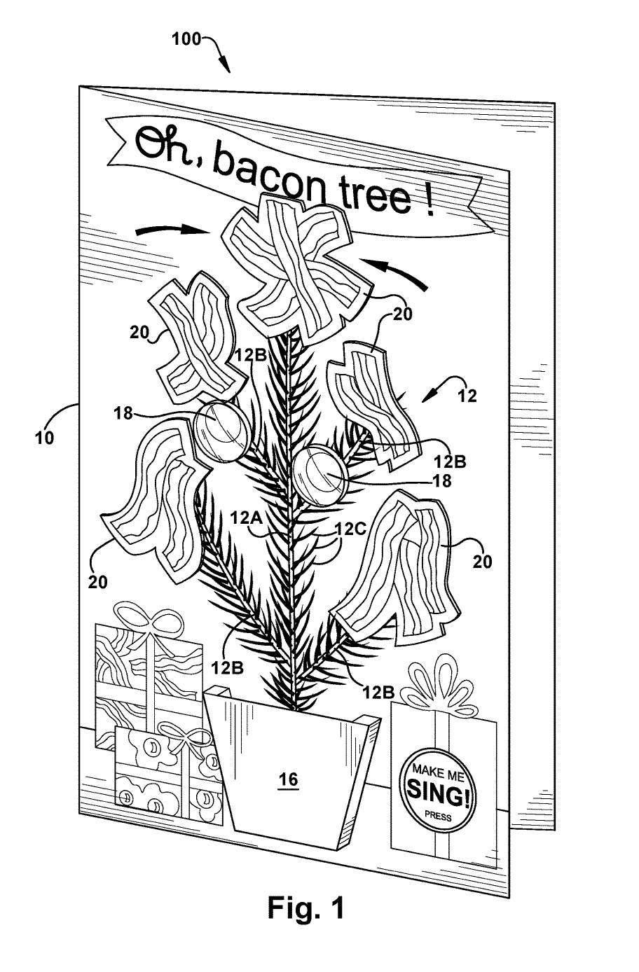

FIG. 2 is a front tear-away view of the greeting card of FIG. 1.

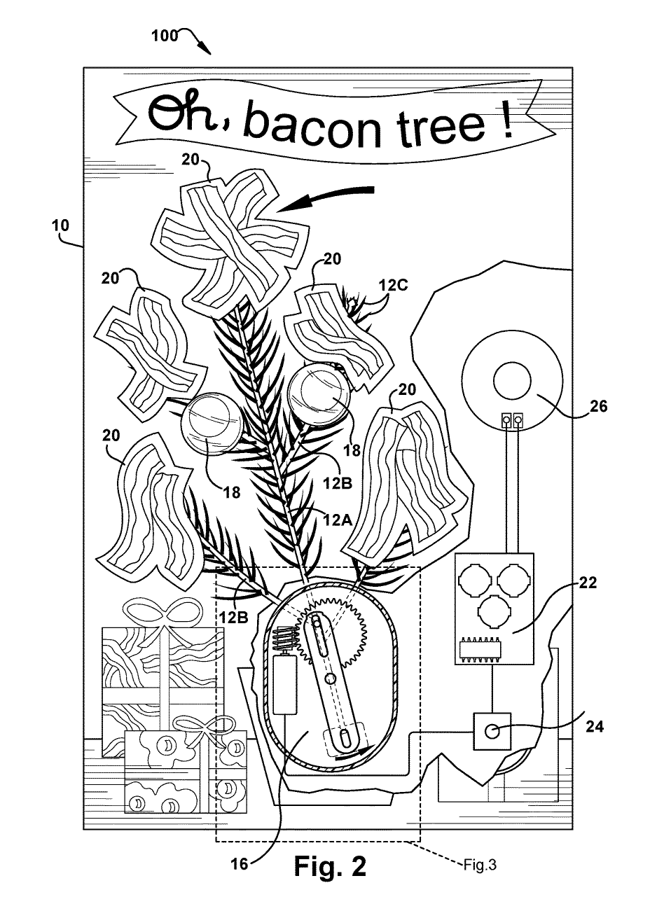

FIG. 3 is a front view of the motor contained within the greeting card of FIG. 1.

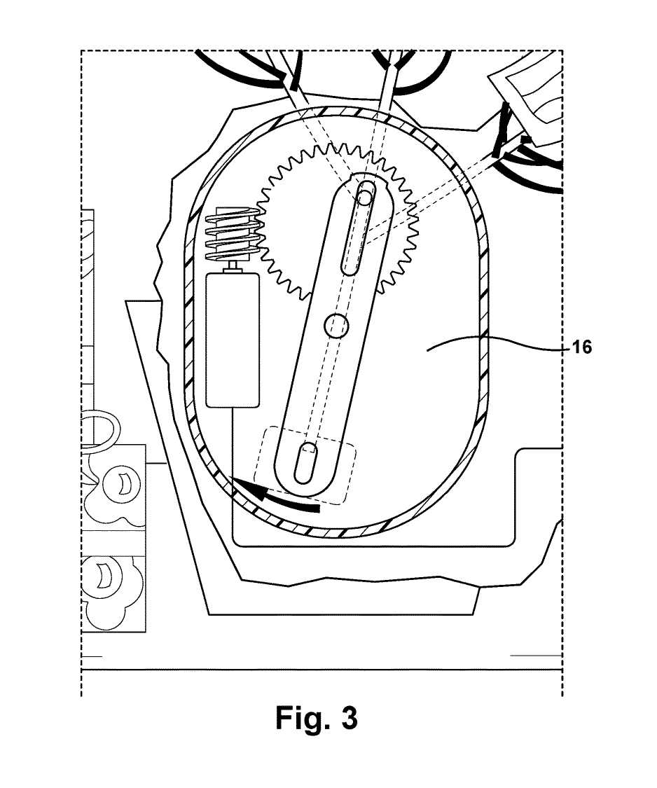

### DETAILED DESCRIPTION OF PREFERRED AND ALTERNATE EMBODIMENTS

The greeting card of the present disclosure and related inventions combines a traditional greeting card with a three-dimensional object, such as a Christmas tree, which is capable of movement and audio playback.

The greeting card body 10, in a preferred embodiment, contains three main greeting card panels which are attached in a row via two main fold lines. A first greeting card panel is attached to a second greeting card panel along a first fold line and a third greeting card panel is attached to the second greeting card panel along a second fold line. Each of the main greeting card panels contains a front surface and a rear surface opposite the front surface. Electronic components, discussed in further detail below, are attached to a front surface of the second (or center) greeting card panel. The third greeting card panel is then folded over the front surface of the second (or center) greeting card panel about the second fold line (such that the front surface of the third panel faces the front surface of the second panel) and attached thereto along all free edges, containing a cavity therebetween, wherein the electronic components reside. The first greeting card panel is then folded beneath the second greeting card panel (such that the rear surface of the first panel faces the rear surface of the second panel) about the first main fold line, to form a traditional two panel greeting card. As assembled, the rear surface of the third greeting card panel (which is now attached to the front surface of the second greeting card panel) serves as the front face of the greeting card. The rear surface of the second greeting card panel serves as the inside left panel of the greeting card. The rear surface of the first greeting card panel serves as the inside right panel of the greeting card and the front surface of the first greeting card panel serves as the rear cover of the greeting card. The greeting card body 10 then opens and closes by pivoting the front cover (second and third attached panels) about the first main fold line, away from (to open) or toward (to close) the rear cover of the greeting card (first panel). The greeting card body 10, in a preferred embodiment, is made of paperboard or other similar sturdy material, but can be made of other materials, such as paper, cardboard, plastic, or any other suitable material. Each of the panels of the greeting card body 10 may contain printing thereon, such as text sentiment, drawings, pictures, photographs or any other type of print. The panels may additionally contain embellishments such as googly eyes, gems, or any other such adornment. The surface of each greeting card panel may be planar or they may contain a cover material which is non-planar, such as faux fur, glitter, or any other textured material. The edges of the greeting card body 10 may be linear or they may be non-linear containing curves, arches or other non-linear patterns.

A three-dimensional (3D) object 12, such as, in a preferred embodiment, a faux Christmas tree, is attached to at least one panel of the greeting card body 10. The 3D faux Christmas tree 12 contains a main branch or stem 12A extending vertically upward and having two or more minor branches or limbs 12B attached at one end thereto which extend upward and outward from the main branch or stem 12A on either the right or left side thereof The main branch or stem 12A can be made of metal or hard plastic or any other sufficiently rigid material (to maintain the object 12 in position). If the main branch 12A is made of metal, it may be covered in plastic. The minor branches or limbs 12B may also be made of metal or plastic or any other sufficiently rigid material. The main branch or stem 12A and the minor branches or limbs 12B each contain a plurality of faux needles 12C which extend upward and outward from the center of each branch 12A, 12B, to resemble a typical Christmas tree. In a preferred embodiment, as shown in the figures, the Christmas tree 12 contains a main branch or stem 12A and four minor branches or limbs 12B attached thereto, two branches 12B extending upward and outward from the left side of the main branch 12A and two branches 12B extending upward and outward from the right side of the main branch 12A. The main branch or stem 12A contains a first or lower end and a second or upper end. The minor branches or limbs 12B are attached to the main branch or stem 12A somewhere between the first (or lower) and second (or upper) ends. The first (or lower end) of the main branch or stem 12A is attached to a motor module 14 (either direction or via a connection arm, piece or other connection mechanism). A small paper construct which resembles a base or a pot 16 is attached to the greeting card body 10 over the first (or lower end) of the main branch or stem 12A to conceal the point of attachment of the main branch or stem 12 and the motor module 14. The paper construct gives the illusion that the faux Christmas tree 12 is planted inside the base or pot structure 16. The faux Christmas tree 12 may additionally contain two googly eyes 18 attached thereto on an upper portion thereof to give the tree a more animated appearance. A plurality of small faux ornaments 20 may also be attached to the main branch or stem 12A and the minor branches or limbs 12B. The faux ornaments 20 may be paperboard shapes die cut to resemble Christmas tree ornaments or bulbs or they may actually be miniature Christmas tree ornaments. The ornaments (faux or otherwise) 20 may be attached to the branches 12A, 12B via glue or other attachment mechanism. In a preferred embodiment, the faux Christmas tree 12 is attached to a front surface of the greeting card body 10, although in other embodiments, it may be located on any panel of the greeting card body 10.

As mentioned above, the electronic components of the greeting card 100 of the present invention are attached to the second or middle greeting card panel prior to the attachment of the third greeting card panel forming a cavity therebetween. The electronic components may be attached directly to the second and/or third greeting card panel or they may be placed and attached onto a separate substrate and then either attached to the second and/or third greeting card panel or inserted therebetween. The electronic components may include, but are not limited to: a printed circuit board 22, an integrated circuit chip, a memory device; a switch 24, a speaker 26, a motor 16, a power source (such as one or more small cell batteries) 28 related wiring and circuitry, any other component which is required to or which facilitates audio storage and playback and motor movement of one or more moveable objects attached to or contained within the greeting card. In a preferred embodiment, a press button switch 24 is used to simultaneously activate both the sound and motor 16 modules. When a user pushes the push button 24 (which may be indicated on the card by a sticker or printing indicating “press” or “press here”) the sound module is activated and begins replay of the at least one audio file through the speaker 26, while the motor module 16 is simultaneously activated, causing a back and forth motion of the faux Christmas tree 12. The design of the faux Christmas tree 12 (with googly eyes 18 and ornaments 20) combined with the audio and motor movement give the impression of a faux, singing and dancing Christmas tree. Additional components may be used to provide additional features such as one or more LED lights.

In other embodiments, the faux talking and dancing Christmas tree may alternatively be attached to a gift bag instead of a greeting card. The Christmas tree may be placed on the outer surface of a gift bag and the sound and motor modules may be placed between a double walled panel of the gift bag. The sound and motor modules may be initiated by a press button switch, similar to the greeting card described above, or the sound and motor modules may be activated by pulling up on the handles of the gift bag or by movement of the gift bag, or by any other conceivable means.

In another embodiment, the greeting card or gift bag may contain a recording module to provide the user with the ability to record and save a personalized message to the greeting card recipient. This embodiment may include two electro-mechanical switches to initiate a recording session and a playback session and a microphone.

In yet another embodiment, the faux Christmas tree may contain one or more lights contained thereon. The lights may be illuminated (along with activation of the sound and motor modules) upon the user pressing the push button or the lights may be illuminated upon activation of a separate switch mechanism. The lights may be pre-programmed to flash, blink, twinkle, strobe, fade in and out, or to effect any other light pattern, either in sequence or randomly.

In still another embodiment, the faux Christmas tree element of the greeting card (or gift bag) may be removable from the greeting card or gift bag and kept by the recipient as a small token gift or keepsake. The electronics required to effect movement and audio would be contained in the base of the faux Christmas tree so that removal of the tree from the greeting card or gift bag would not prevent the use of these features.

While the greeting card (or gift bag) of the present invention has been described herein and shown in the figures as having three greeting card panels, the greeting card body may contain fewer than three greeting card panels, such as one or two, or more than three greeting card panels, such as four, five or six or more. The greeting card panels may be configured in alternate configurations such as vertically, instead of horizontally such that the greeting card opens in an up and down direction as opposed to a right and left direction as described herein with respect to the preferred embodiment and also may be folded or arranged in alternate configurations. Other materials for the greeting card body and other adornments or embellishments have been contemplated and are considered to be within the scope of this invention. Additionally, while a push button switch has been described herein as the method by which a user interacts with the greeting card to initiate the sound and motor modules, other switches may be used in addition to or in place of the push button switch. Such switches may include, but are not limited to: a slide switch, a contact switch, a touch sensitive switch, a light sensitive switch, a motion sensitive switch, an on/off switch, a tilt switch, a pull-tab switch, or any other switch. A single switch may be used to initiate both the sound and motor modules (simultaneously or otherwise), as described above, or two separate switches (of the same kind or different) may be used to separately initiate the sound and motor modules. The sound module may contain more than one audio file or clip thereon such that pressing the push button consecutive times causes different audio files to be replayed through the speaker. Also, the greeting card has been described herein as having a dancing and singing faux Christmas tree attached thereto. In lieu of the faux Christmas tree, other faux objects may be used, such as a flower, an animal, a character, a cupcake, or any other conceivable object.

1. A greeting card comprising:
a greeting card body;
a three-dimensional mobile object the form of a Christmas tree having a main branch and one or more minor branches extending outward therefrom;
a motor module contained within a cavity in the greeting card body, the motor module attached to the three-dimensional mobile object;
a switch which controls activation of the motor module;
wherein activation of the motor module causes movement of the three-dimensional mobile object.

2. The greeting card of claim 1 further comprising a sound module, the sound module contained within the cavity in the greeting card body and operative to store and playback at least one audio file.

3. The greeting card of claim 2, wherein the switch controls activation of the sound module.

4. The greeting card of claim 1, wherein the three-dimensional mobile object is attached to a front surface of the greeting card.

5. The greeting card of claim 1, wherein the switch is a push button switch.

6. The greeting card of claim 1, wherein when activated, the motor module causes the three-dimensional mobile object to move in a lateral back-and-forth direction.

7. The greeting card of claim 1, wherein the three-dimensional mobile object contains one or more embellishments thereon.

8. A greeting card comprising:
a multi-panel greeting card body having one or more cavities contained therein;
a faux Christmas tree attached to one panel of the multi-panel greeting card body;
a motor module contained within the one or more cavities of the multi-panel greeting card body, the motor module connected to the faux Christmas tree and operative to effect movement thereof;
a switch contained within the multi-panel greeting card body which controls activation of the motor module.

9. The greeting card of claim 8 further comprising a sound module contained within the one or more cavities in the multi-panel greeting card body.

10. The greeting card of claim 9, wherein the switch controls activation of the sound module.

11. The greeting card of claim 8, wherein the switch is a push-button switch.

12. The greeting card of claim 8, wherein the switch is accessed through a front cover of the greeting card.

13. The greeting card of claim 8, wherein the faux Christmas tree is operable to move in opposing lateral directions.

14. The greeting card of claim 8, wherein the faux Christmas tree contains two moving eye discs attached thereto.

15. A greeting card comprising:
a greeting card body having at least one cavity therein;
a mobile object having two or more die cut shaped attached thereto;
a motor module contained within the at least one cavity of the greeting card body, connected to the mobile object and operative to effect movement thereof;
a sound module contained within the at least one cavity of the greeting card body, the sound module operative to store and playback at least one audio file;
a switch which controls activation of the motor and sound modules.

16. The greeting card of claim 15, wherein the mobile object is a faux Christmas tree.

17. The greeting card o claim 15, wherein the mobile object moves in a back-and-forth motion when the motor module is activated.

18. The greeting card of claim 15, wherein the mobile object is attached to a front surface of the greeting card.

19. The greeting card of claim 15, wherein the switch is a push-button switch.

20. The greeting card of claim 15, wherein the switch is activated through a front surface of the greeting card.
